(19) United States
(12) Patent Application Publication
(10) Pub. No.: US 2003/0012545 A1
(43) Pub. Date: Jan. 16, 2003

(54) Broad-band variable optical attenuator

(76) Inventors: Robert A. Bellman, Painted Post, NY (US); James G. Couillard, Ithaca, NY (US); Donald M. Trotter JR., Newfield, NY (US); Ljerka Ukrainczyk, Painted Park, NY (US)

Correspondence Address: CORNING INCORPORATED, SP-TI-3-1, CORNING, NY, 14831

(21) Appl. No.: 10/134,015

(22) Filed: Apr. 25, 2002

Related U.S. Application Data
(60) Provisional application No. 60/303,592, filed on Jul. 5, 2001.

(51) Int. Cl. G02B 6/26; G02B 6/32; G02B 6/38

(52) U.S. Cl. 385/140; 385/33; 385/74

(57) ABSTRACT

A variable optical attenuator includes a pair of lensed fibers normally having their optical axes aligned and an actuator operable to displace at least one of the pair of lensed fibers such that the optical axes are misaligned and an intensity of an optical signal passing between the lensed fibers is altered.

### CROSS-REFERENCE TO RELATED APPLICATIONS

This application claims priority from U.S. Provisional Application Serial No. 60/303,592, entitled “Broad-Band Variable Optical Attenuator,” filed Jul. 5, 2001.

### BACKGROUND OF INVENTION

1. Field of the Invention

The invention relates generally to fiber-optic communication systems. More specifically, the invention relates to a device for variably reducing optical power.

2. Background Art

In fiber-optic communication systems, information is encoded into optical signals and transferred from one location to another through optical fibers. It is often desirable to tailor the strength of the optical signals to within a target range. For example, in fiber-optic communication systems based on wavelength-division-multiplexing (WDM), there is an optimum level of optical power where optical receivers work best, and it is usually desirable to tailor the optical signals in these systems to this optimum level. Variable optical attenuators are used for reducing optical power in fiber-optic communication systems. Variable optical attenuators can be inserted in WDM systems to tailor the strength of optical signals to the desired optimum level before the optical signals are delivered to the optical receivers.

Variable optical attenuators are generally characterized by their speed, attenuation range, repeatability and control of attenuation, and polarization and wavelength dependence. Various designs of variable optical attenuators are available, including electromechanical, thermo-optic, and magneto-optic designs. Electromechanical variable optical attenuators are generally slow and difficult to align with optical fibers. Planar variable optical attenuators using thermo-optic phase shifters are also slow, show strong polarization- and wavelength-dependent attenuation, and require cascading to achieve a wide dynamic range. Interferometer-based variable optical attenuators, such as Mach-Zehnder Interferometer (MZI), with electro-optic phase shifters are fast, but are expensive, have a wavelength-dependent attenuation, and polarization management is required.

### SUMMARY OF INVENTION

In one aspect, the invention relates to a variable optical attenuator which comprises a pair of lensed fibers normally having their optical axes aligned and an actuator operable to displace at least one of the lensed fibers such that the optical axes of the lensed fibers are misaligned and an intensity of an optical signal passing between the lensed fibers is altered.

In another aspect, the invention relates to a device for attenuating an optical beam which comprises a microelectronic substrate having a cantilever defined therein, a lensed fiber supported by the cantilever, and an actuator operable to deflect the cantilever such that an optical axis of the lensed fiber is deflected from a normal position.

In another aspect, the invention relates to a device for attenuating an optical beam which comprises a pair of lensed fibers normally having their optical axes aligned, a cantilever which supports one of the lensed fibers, and an actuator for deflecting the cantilever such that the optical axes of the lensed fibers are misaligned and an intensity of an optical signal passing between the lensed fibers is altered.

In another aspect, the invention relates to a device for attenuating an optical beam which comprises an array of cantilevers, an array of lensed fibers supported by the array of cantilevers, and an array of actuators operable to selectively deflect the cantilevers.

In another aspect, the invention relates to a device for attenuating an optical beam which comprises an array of cantilevers, a first array of lensed fibers supported by the cantilevers, and a second array of lensed fibers arranged in opposing relation to the first array of lensed fibers. The second array of lensed fibers have their optical axes normally aligned with the optical axes of the first array of lensed fibers. The device further comprises an array of actuators for selectively deflecting the cantilevers such that an intensity of an optical signal passing between the first array of lensed fibers and the second array of lensed fibers is altered.

In another aspect, the invention relates to a method for attenuating an optical beam which comprises passing the optical beam between a pair of lensed fibers normally having their optical axes aligned and displacing at least one of the lensed fibers such that the optical axes of the lensed fibers are misaligned and an intensity of the optical beam is altered.

Other features and advantages of the invention will be apparent from the following description and the appended claims.

### BRIEF DESCRIPTION OF DRAWINGS

FIG. 1A shows a variable optical attenuator having a pair of lensed fibers.

FIG. 1B shows a pair of lensed fibers having their optical axes laterally misaligned.

FIG. 1C shows a pair of lensed fibers having their optical axes angularly misaligned.

FIG. 1D shows a pair of lensed fibers having their optical axes both laterally and angularly misaligned.

FIG. 2A shows a graph of angular offset versus lateral offset for a pair of lensed fibers having their optical axes both laterally and angularly misaligned.

FIG. 2B shows a graph of attenuation versus lateral offset for a pair of lensed fibers having their optical axes both laterally and angularly misaligned.

FIG. 3A shows a perspective view of a MEMS device having a cantilever that supports a lensed fiber and a bimetal actuator for deflecting the cantilever.

FIG. 3B shows a side view of the MEMS device shown in FIG. 3A.

FIG. 3C shows the MEMS device of FIG. 3B in a deflected position.

FIG. 4 is a top view of a variable optical attenuator that includes a pair of the MEMS device shown in FIG. 3A.

FIG. 5A shows a microelectronic substrate.

FIG. 5B shows a thin insulating film deposited on the microelectronic substrate.

FIG. 5C shows a bimetal strip deposited on the thin insulating film.

FIG. 5D shows a cavity formed in the microelectronic substrate.

FIG. 5E shows an electrical contact deposited on the microelectronic substrate.

FIG. 5F shows the microelectronic substrate undercut to form a cantilever.

FIG. 6 shows a MEMS device having a cantilever and two bimetal strips deposited on the upper surface of the cantilever.

FIG. 7 shows a side view of a MEMS device having a cantilever with a constriction formed at the base of the cantilever.

FIG. 8 shows a vertical cross-section of a MEMS device having a cantilever and bimetal strips deposited on the upper and bottom surfaces of the cantilever.

FIG. 9A shows an electrostatic actuator for displacing a lensed fiber according to an embodiment of the invention.

FIG. 9B shows the electrostatic actuator of FIG. 9A in a deflected position.

FIG. 10 shows a magnetic actuator for displacing a lensed fiber according to an embodiment of the invention.

FIG. 11A shows a top view of a variable optical attenuator according to another embodiment of the invention.

FIG. 11B is a cross-section of FIG. 11A.

FIG. 11C shows the cantilever of FIG. 11B in a deflected position.

FIG. 12A shows a motor coupled to a stage holding a lensed fiber.

FIG. 12B shows a support structure holding a lensed fiber aligned with the stage shown in FIG. 12A.

FIG. 12C shows the stage of FIG. 12A laterally displaced by a motor.

FIG. 13 shows a graph of attenuation versus lateral offset for three different mode fields using a motor as the mechanism for displacing the lensed fiber.

### DETAILED DESCRIPTION

Embodiments of the invention provide a variable optical attenuator that is operable over a wide range of wavelengths, has a low insertion loss, e.g., less than 0.2 dB, has a large dynamic range of attenuation, e.g., greater than 40 dB, and does not depend on polarization.

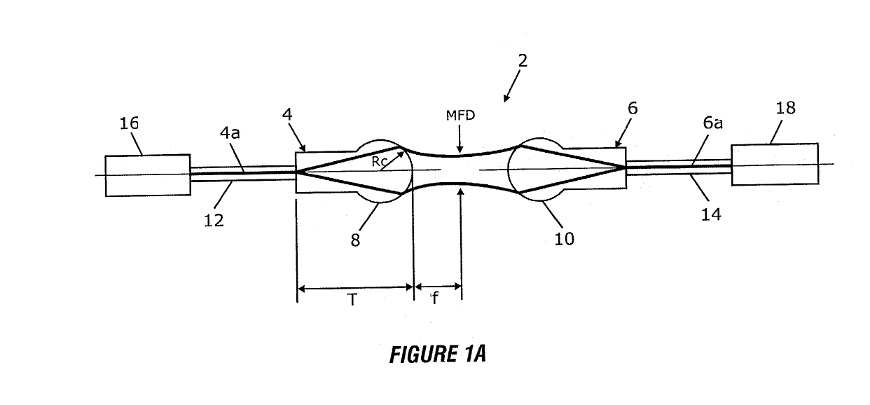

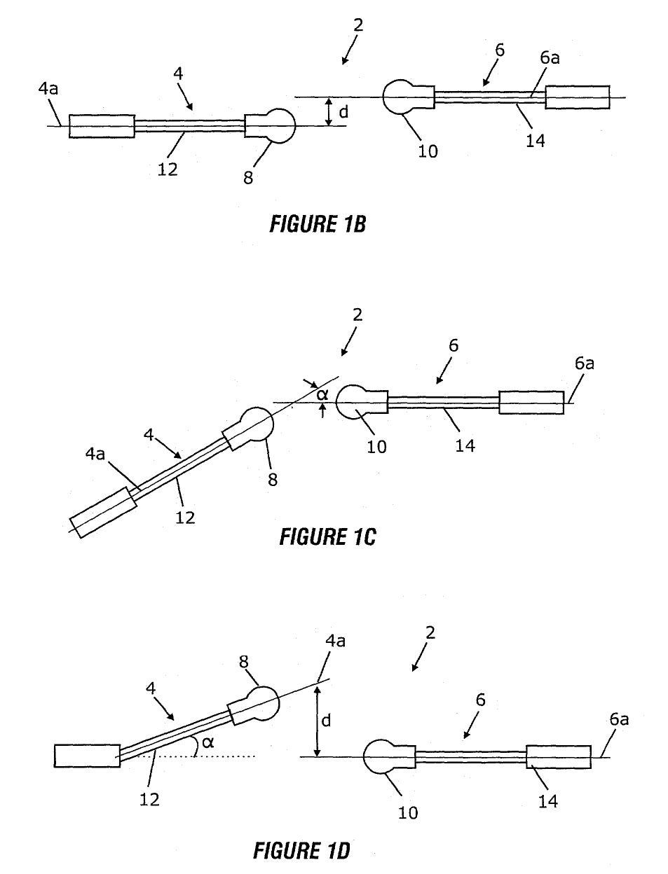

FIGS. 1A-1D illustrate the basic concept of the variable optical attenuator of the invention. As shown in FIG. 1A, the variable optical attenuator, generally indicated at 2, includes two lensed fibers 4, 6. A lensed fiber is a monolithic device having an optical fiber terminated with a lens. As shown, the lensed fibers 4, 6 include planoconvex lenses 8, 10 attached to, or formed at, the ends of optical fibers 12, 14, respectively. The optical fibers 12, 14 are stripped regions of coated optical fibers 16, 18, respectively. The optical fibers 12, 14 may be single-mode fibers, including polarization-maintaining fibers, or multimode fibers. The planoconvex lenses 8, 10 expand light passing between the optical fibers 12, 14 into a collimated beam. The planoconvex lenses 8, 10 are coated with an anti-reflection coating to minimize back-reflection. Reflection loss is typically greater than −60 dB.

In the arrangement shown in FIG. 1A, the planoconvex lenses 8, 10 oppose each other and are spaced away from each other. The lensed fibers 4, 6 are arranged such that their optical axes 4a, 6a, respectively, are aligned. Assume that the lensed fiber 4 is at the input end of variable optical attenuator 2. Then the light transmitted to the lensed fiber 4 travels through the optical fiber 12 and is expanded into a collimated beam by the planoconvex lens 8. The collimated beam is collected by the planoconvex lens 10 and then focused into the optical fiber 14 of the lensed fiber 6.

The thickness (T) and radius of curvature (Rc) of the planoconvex lens 8 determine the axial distance (f) from the convex surface of the lens 8 to the beam waist. The mode field diameter (MFD) is determined by the thickness (T), radius of curvature (Rc), and distance to beam waist (f) of the lens 8. Typical coupling efficiency of the lensed fibers 4, 6 when their optical axes 4a, 6a are aligned is below 0.2 dB.

In accordance with the invention, optical power is attenuated by displacing one or both of the lensed fibers 4, 6 such that the optical axes 4a, 6a of the lensed fibers 4, 6 are laterally and/or angularly misaligned. FIG. 1B shows a scenario wherein the optical axes 4a, 6a are laterally misaligned by an offset d. FIG. 1C shows a scenario wherein the optical axes 4a, 6a are angularly misaligned by an angle α. FIG. 1D shows a scenario wherein the optical axes 4a, 6a are laterally misaligned by an offset d and angularly misaligned by an angle α. When the optical axes 4a, 6a are misaligned, the amount of power transmitted from the input lensed fiber 4 to the output lensed fiber 6 is smaller in comparison to the amount of power that would have been transmitted if the optical axes 4a, 6a were aligned. The amount of optical power coupled into the output lensed fiber 6 depends on the degree of misalignment between the optical axes 4a, 6a.

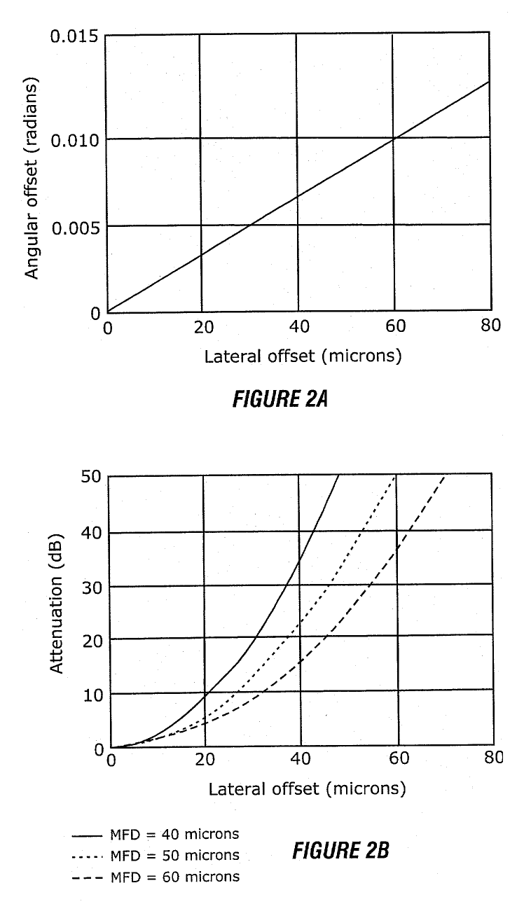

FIG. 1D shows that angular misalignment of the optical axes 4a, 6a can induce lateral misalignment of the optical axes 4a, 6a as well. FIG. 2A shows how much lateral offset results from angular offset of the optical axes 4a, 6a (see FIG. 1D). The relationship between angular offset and lateral offset is approximately linear over the small range of angles considered. In general, the relationship between lateral offset and angular offset is nonlinear. FIG. 2B shows calculated attenuation due to both angular and lateral misalignment of the optical axes 4a, 6a (see FIG. 1D). Attenuation is plotted as a function of lateral offset of the optical axes 4a, 6a (see FIG. 1D) and the mode field diameter (MFD) at the beam waist. For the calculations, the sum of the length of the lensed fiber (4 in FIG. 1D) and axial distance from the convex surface of the lens (8 in FIG. 1D) to the beam waist is assumed to be 6 mm. As shown in the graph, as the mode field diameter (MFD) at the beam waist decreases, the lateral offset (d in FIG. 1D) needed to achieve the desired attenuation level also decreases.

Returning to FIG. 1A, actuators are needed to displace the lensed fibers 4, 6 so that the optical axes 4a, 6a are laterally and/or angularly misaligned. Any actuator that can provide translational and/or rotational motion can be used to displace the lensed fibers 4, 6 such that the desired level of attenuation is achieved. A feedback system can be provided to control the operation of the actuators such that the lensed fibers 4, 6 are displaced by an amount corresponding to the desired level of attenuation. The feedback system may receive an attenuation signal that indicates the level of attenuation needed and a power signal that indicates the current power transmitted to the variable optical attenuator 2. Based on the attenuation signal and the power signal, the feedback system would then determine the amount by which the lensed fibers 4, 6 should be displaced to achieve the specified level of attenuation. Power signals from the input and output lensed fibers may be compared to determine if the desired level of attenuation is achieved. If not, the feedback system may further determine the amount by which the lensed fibers should be displaced to achieve the desired level of attenuation.

Specific embodiments of the invention are described below, including specific examples of actuators suitable for use in the invention. However, it should be clear that the invention is not limited to these specific examples of actuators. In particular, it should be clear that the main principle of the invention is the misalignment of the optical axes of paired lensed fibers such that the amount of light coupled between the paired lensed fibers is altered or reduced. As illustrated below, the actual method used in misaligning the optical axes can be widely varied.

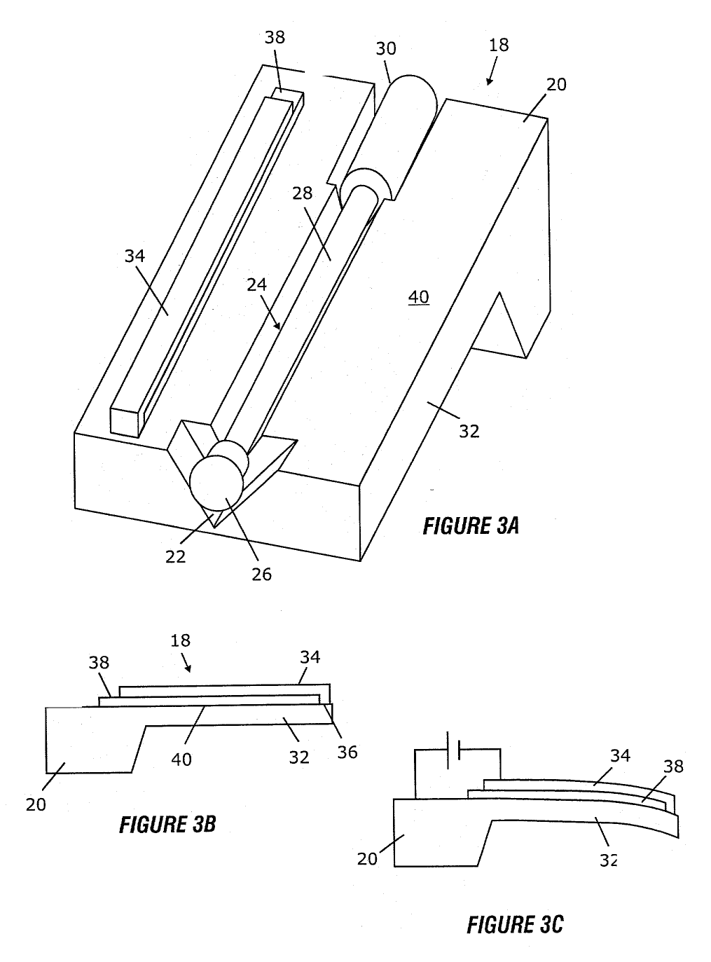

FIG. 3A shows an embodiment of the invention wherein a cantilever 32 driven by thermal expansion of a bimetal strip or actuator 34 is used to displace a lensed fiber 24. This embodiment of the invention is implemented as a Micro-Electro-Mechanical-Systems (MEMS) device, generally indicated at 18. MEMS is a manufacturing technology that enables integration of mechanical and electromechanical devices and electronics on a common silicon wafer or, more generally, a common microelectronic substrate. MEMS devices are produced using a combination of integrated circuit fabrication techniques and micromachining processes. MEMS devices have the advantage of low cost fabrication, high reliability, and extremely small size.

The MEMS device 18 includes a microelectronic substrate 20 micromachined to produce the cantilever 32. The cantilever 32 has a cavity 22, such as a V-groove, for holding the lensed fiber 24. The lensed fiber 24 includes a planoconvex lens 26 attached to one end of an optical fiber 28. The other end of the optical fiber 28 is a stripped region of a coated optical fiber 30. The lensed fiber 24 may be secured inside the cavity 22 using epoxy or other suitable bonding material. When the cantilever 32 is deflected, the lensed fiber 24 also deflects. The mechanism for deflecting the cantilever 32 includes the bimetal strip 34, which is deposited on the cantilever 32. The bimetal strip 34 is made of materials having different coefficients of thermal expansion.

FIG. 3B shows a side view of the MEMS device 18 (previously shown in FIG. 3A). The bimetal strip 34 is isolated from the bulk of the microelectronic substrate 20 by a thin insulating film 38 deposited between the bimetal strip 34 and the upper surface 40 of the cantilever 32. A portion of the bimetal strip 34 contacts an end portion 36 of the cantilever 32. This allows the microelectronic substrate 20 to be used as a source of electrical contact with the bimetal strip 34. When current is applied to the bimetal strip 34, resistive losses in the bimetal material causes the bimetal strip 34 to heat up and expand. As illustrated in FIG. 3C, the bimetal strip 34 bends as it expands, causing the cantilever 32 to deflect. The amount of current passed through the bimetal strip 34 determines the extent to which the cantilever 32 deflects.

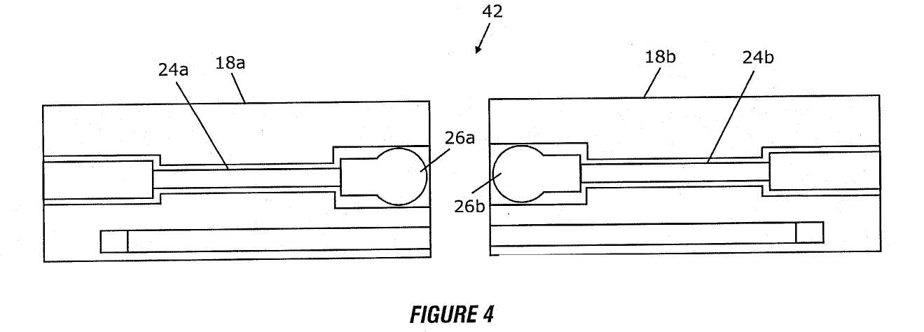

FIG. 4 shows a variable optical attenuator 42 having two MEMS devices, identified by reference numerals 18a and 18b. The MEMS devices 18a, 18b are similar to the MEMS device (18 in FIG. 3A) described above. The MEMS devices 18a, 18b are arranged such that their lenses 26a, 26b, respectively, are in opposing relation. In this scenario, one or both of the MEMS devices 18a, 18b can be activated to displace one or both of the lensed fibers 24a, 24b to achieve the desired level of attenuation.

In an alternate embodiment, one of the MEMS devices 18a, 18b, say MEMS device 18b, may be replaced with a structure (not shown), such as a V-groove block, that holds a second lensed fiber. This second lensed fiber would be aligned with the lensed fiber 24a in the remaining MEMS device 18a. In this scenario, the structure holding the second lensed fiber does not need to include a mechanism for displacing the second lensed fiber. Rather, only the lensed fiber 24a in the MEMS device 18a is displaced to achieve the desired level of attenuation.

The variable optical attenuator can also be an arrayed device, including an array of MEMS devices (18 in FIG. 3A) that can be paired with other MEMS devices or structures holding lensed fibers. The arrayed MEMS devices can be selectively activated to achieve a desired level of attenuation.

Returning to FIG. 3A, the MEMS device 18 can be constructed using a combination of known integrated circuit fabrication techniques and micromachining processes. The following is a brief discussion of one possible method of constructing the MEMS device 18. However, those skilled in the art will understand that the combination of techniques for producing the MEMS device 18 can be widely varied.

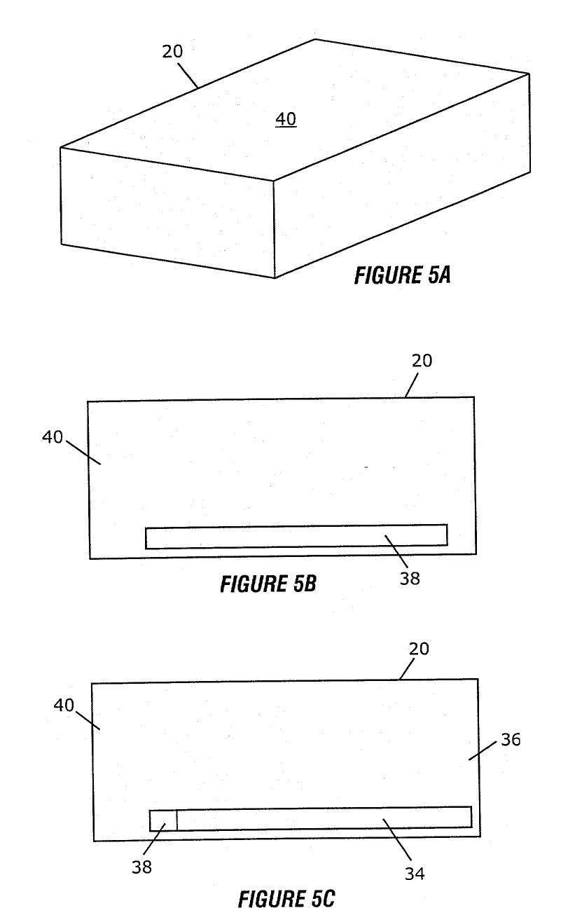

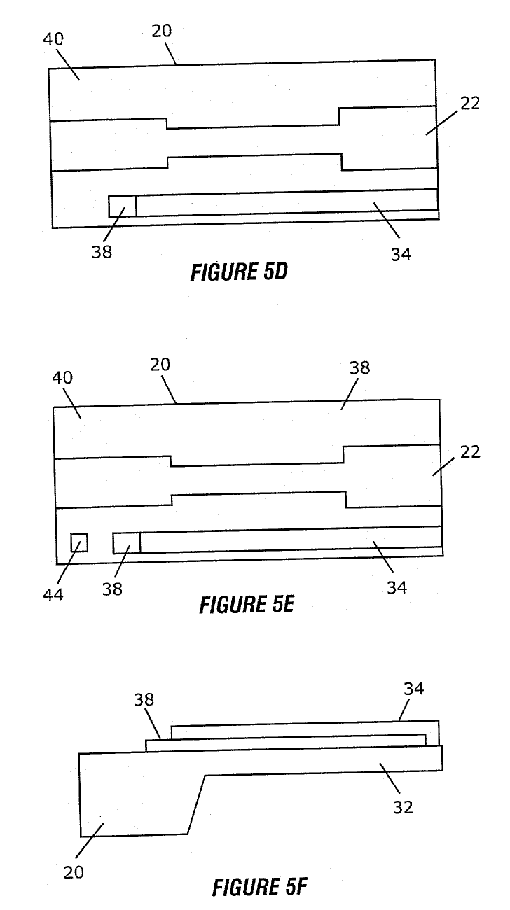

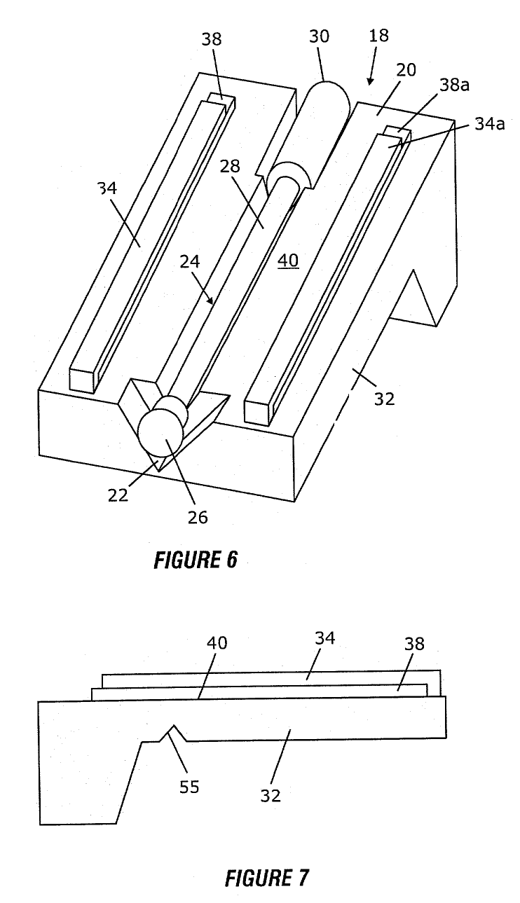

FIG. 5A shows the microelectronic substrate 20 before being micromachined to produce a cantilever. The upper surface 40 of the microelectronic substrate 20 is generally planar. The microelectronic substrate 20 could be a silicon wafer or other suitable substrate material. For example, the microelectronic substrate 20 could be silicon on insulator (SOI) substrate, silicon wafer bonded to glass substrate, or polysilicon or amorphous silicon film deposited on glass substrate. In general, it is desirable for the microelectronic substrate 20 to be thermally conductive to remove unwanted heat. It is also generally desirable for the microelectronic substrate 20 to be electrically conductive so that it can be used as one arm of a bimetal actuator or as a ground plane. Hybrid substrates, such as SOI, silicon bonded to glass, or polysilicon or amorphous silicon deposited on glass offer the advantage of a large difference in etch rates between the silicon and the insulator, which can be used to define the cantilever.

FIG. 5B shows the thin insulating film 38 deposited on the upper surface 40 of the microelectronic substrate 20. Examples of suitable materials for the insulating film 38 include, but are not limited to, silicon dioxide (SiO₂), silicon nitride (Si₃N₄), and glasses such as borophosphosilicate glass (BPSG). Any of a number of deposition techniques may be used, such as plasma deposition, chemical deposition, and so forth.

FIG. 5C shows the bimetal strip 34 deposited on the thin insulating film 38. A portion of the bimetal strip 34 contacts the upper surface 40 of the microelectronic substrate 20 at the end portion 36 of the microelectronic substrate 20.

FIG. 5D shows the cavity 22 formed in the microelectronic substrate 20. The cavity 22 may be formed using techniques such as photolithographic patterning followed by chemical or plasma etching.

FIG. 5E shows an electrical contact 44 deposited on the microelectronic substrate 20. The electrical contact 44 is used to supply current to the bimetal strip 34.

FIG. 5F shows the microelectronic substrate 20 undercut to form the cantilever 32. The microelectronic substrate 20 may be undercut by micromachining processes such as chemical or plasma etching.

Various alternate configurations of the MEMS device 18 (previously shown in FIG. 3A) are possible. In the alternative configuration shown in FIG. 6, a bimetal strip 34a has been added to the upper surface 40 of the cantilever 32. This bimetal strip 34a is in addition to the bimetal strip 34 on the upper surface 40 of the cantilever 32. The lensed fiber 24 is situated between the bimetal strips 34, 34a. A thin insulating film 38a is deposited between the bimetal strip 34a and the upper surface 40 of the cantilever 32 to isolate the bimetal strip 34a from the bulk of the microelectronic substrate 20. The embodiment shown in FIG. 6 operates in a similar manner to the embodiment shown in FIGS. 3A-3C. In operation, when current is applied to the bimetal strips 34, 34a, the bimetal strips 34, 34a expand, bend, and cause the cantilever 32 and lensed fiber 24 to deflect. To facilitate easier movement of the cantilever 32, the cantilever 32 may be constricted at the base, as shown at 55 in FIG. 7. In general, it is desirable that the geometry of the cantilever 32 is such that there is high stiffness perpendicular to the plane of the cantilever 32 and low stiffness in the plane of the cantilever 32.

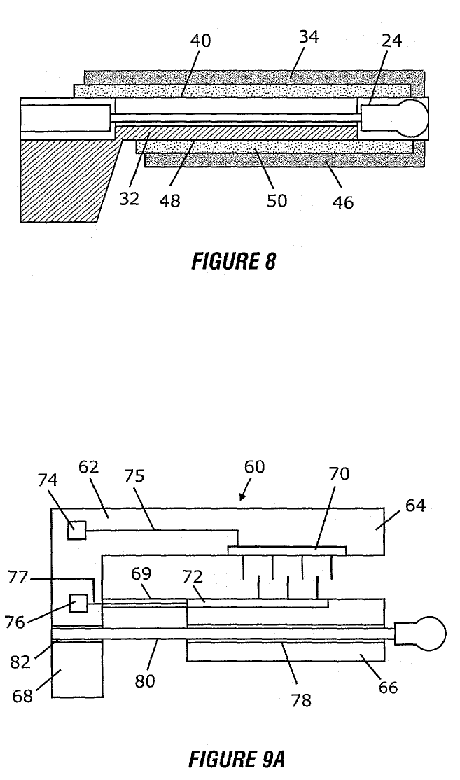

In the alternate configuration shown in FIG. 8, a bimetal strip 46 is added to the bottom surface 48 of the cantilever 32. The bimetal strip 46 is in addition to the bimetal strip 34 at the upper surface 40 of the cantilever 32. The bimetal strip 46 may be used to achieve a more precise control of the deflection of the cantilever 32 and/or a more rapid response of the cantilever 32 when reducing attenuation. A thin insulating film 50 deposited between the bimetal strip 46 and the bottom surface 48 of the cantilever 32 isolates the bimetal strip 46 from the bulk of the microelectronic substrate 20. The bimetal strip 46 contacts the microelectronic substrate 20 at the end of the cantilever 32. This allows the microelectronic substrate 20 to be used as a source of electrical contact with the bimetal strip 46. When current is applied to the bimetal strip 46, the bimetal strip 46 heats up and expands. The thermal expansion causes the cantilever 32 to deflect in a direction opposite the direction in which the cantilever 32 deflects when current is applied to the bimetal strip 34 on the upper surface 40 of the cantilever 32.

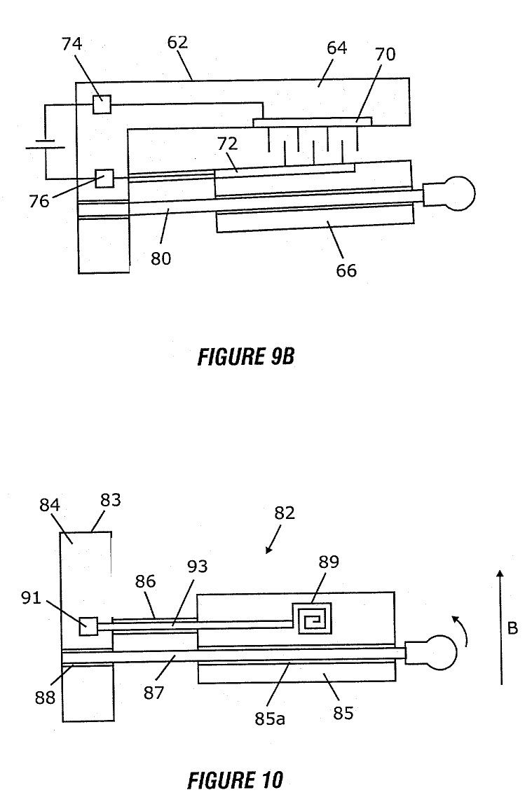

A cantilever driven by thermal expansion of one or more bimetal strips is just one example of a mechanism for displacing a lensed fiber. FIG. 9A shows an electrostatic actuator 60 that can be used to deflect a lensed fiber laterally. In the illustrated embodiment, the electrostatic actuator 60 is implemented as a MEMS device. The electrostatic actuator 60 includes a microelectronic substrate 62 having a horizontal structure 64 and a vertical structure 68. The microelectronic substrate 62 also includes a cantilever 66 coupled to the vertical structure 68 by a connecting arm 69. The cantilever 66 has a cavity 78 for receiving a lensed fiber 80. A portion of the lensed fiber 80 extends into a cavity 82 in the vertical structure 68.

The cantilever 66 is arranged in opposing relation to the horizontal structure 64 and is spaced vertically from the horizontal structure 64. The connecting arm 69 is flexible so as to allow movement of the cantilever 66 relative to the horizontal structure 64. Electrodes 70, 72 are provided on the horizontal structure 64 and the cantilever 66, respectively. The electrodes 70, 72 are in opposing relation and are spaced apart. Electrical contacts 74, 76 are provided on the horizontal structure 64 and the vertical structure 68, respectively. The electrical contacts 74, 76 are connected to the electrodes 70, 72, respectively, by conducting lines 75, 77. When voltage is applied across the electrodes 70, 72, a force is generated that draws the electrodes 70, 72 together, as shown in FIG. 9B. As the electrodes 70, 72 are drawn together, the cantilever 66 moves towards the horizontal structure 64.

Returning to FIG. 9A, the electrostatic actuator 60 can be formed by patterning the microelectronic substrate 62 using deep-etching. The microelectronic substrate 62 is patterned to form the horizontal structure 64, vertical structure 68, cantilever 66, and connecting arm 69. After patterning, the microelectronic substrate 62 can then be electrically isolated by depositing or thermally growing an oxide (or other insulating material) on the surface of the microelectronic substrate 62. The electrodes 70, 72 are then deposited on the microelectronic substrate 62. Next, metallic films are deposited on the microelectronic substrate 62 to form the conducting lines 75, 77. Finally, the electrical contacts 74, 76 are deposited on the microelectronic substrate 62.

Magnetism can also be used to deflect the lensed fiber. FIG. 10 shows a magnetic actuator 82 that can be used to deflect a lensed fiber laterally. In the illustrated embodiment, the magnetic actuator 82 is implemented as a MEMS device. The magnetic actuator 82 includes a microelectronic substrate 83 having a vertical structure 84 and a cantilever 85 coupled to the vertical structure 84 by a connecting arm 86. The connecting arm 86 facilitates lateral movement of the cantilever 85. The cantilever 85 has a cavity 85a for receiving a lensed fiber 87. A portion of the lensed fiber 87 extends into a cavity 88 in the vertical structure 84.

A metallic coil 89 is deposited on the cantilever 85. An electrical contact 91 is provided on the vertical structure 84. The electrical contact 91 is connected to the metallic coil 89 by a conducting line 93. The metallic coil 89 is electrically isolated from the microelectronic substrate 83, except at its center where it uses the microelectronic substrate 83 as a return path. Current flowing through the metallic coil 89 induces a magnetic vector (perpendicular to the page in FIG. 10). If a stationary field B exists, the field will interact with the induced magnetic vector to produce a torque on the cantilever 85 that will deflect the cantilever 85 and the lensed fiber 87.

A piezoelectric or electrostrictive actuator can also be used to deflect a lensed fiber. Piezoelectric and electrostrictive actuators offer an all solid state, highly reliable means of providing motion to deflect the lensed fiber. Piezoelectric stacks providing displacements in the range of 35 to 40 μm, with resolution of 0.1 μm are commercially available. The response time of these devices is about 0.1 milliseconds for full displacement, and these devices have demonstrated 10,000 hours of 100 Hz service with little degradation in performance. However, the required voltage is typically high, e.g., 400 volts, and the devices are typically long, e.g., 72 mm, which is not very appealing for miniaturized devices.

In general, the force required to deflect the lensed fiber is small. Therefore, either positioning the actuator to act on the fiber as a lever to magnify the displacement and/or using a bimorph element would reduce the actuator size and voltage requirements by reducing the required displacement. A bimorph element is made of two piezoelectric elements with different piezoelectric coefficients or a piezoelectric layer deposited on a non-piezoelectric layer. As an example, a bimorph element that is 15 mm long by 2 mm wide can provide a displacement of 120 μm with the application of 60 volts dc. Other examples of displacements possible using just 60 volts dc are listed in Table 1 below. Depending on the degree of miniaturization and the force required, 50 μm displacement could be achieved with as little as 6 volts dc. Preliminary experiments indicate that the required deflection is easily provided by 1 to 2 gmf applied to a fiber lens held fixed by the fiber about ½ inch behind the lens.

TABLE 1

| | | Displacement (μm) | |
|---|---|---|---|
| Length (mm) | Width (mm) | at 60 volts dc | Force (gmf) |
| 15 | 2 | 120 | 12 |
| 25 | 4 | 300 | 15 |
| 25 | 16 | 300 | 60 |
| 35 | 4 | 500 | 10 |
| 35 | 16 | 500 | 40 |

Electrostrictive actuators offer similar forces, displacements, and response times. However, they cannot be inadvertently de-poled as can a piezoelectric actuator; de-poling renders the piezoelectric actuator ineffective. The response of the electrostrictive actuator is proportional to the square of the applied voltage, rather than linear as in the case of the piezoelectric actuator. Thus, only one direction of motion is possible with a single electrostrictive actuator.

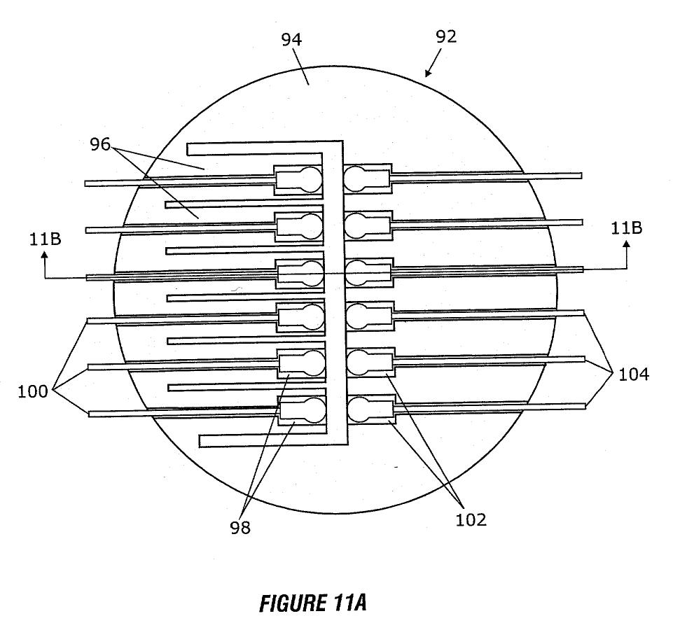

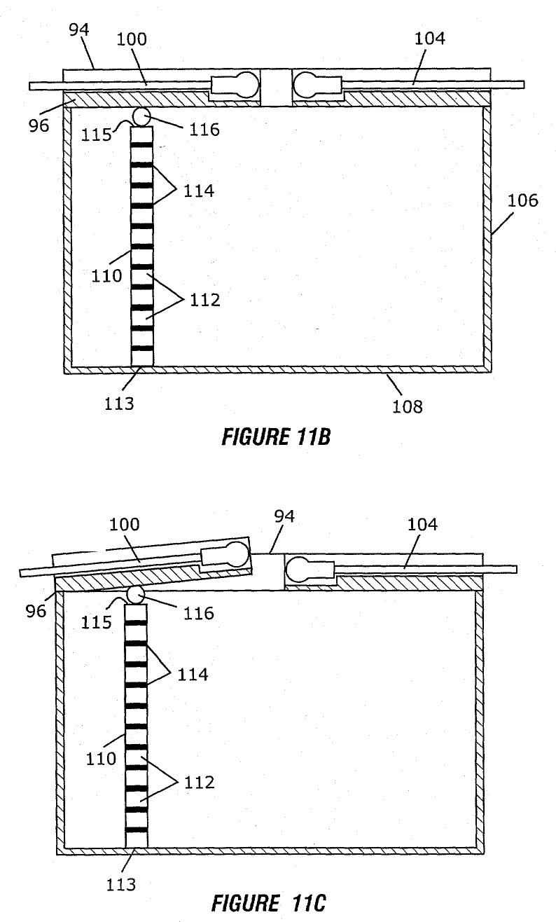

FIG. 11A shows a top view of a variable optical attenuator 92 having a microelectronic substrate 94 micromachined to form an array of cantilevers 96. Each cantilever 96 has a cavity 98 for holding a lensed fiber 100. An array of cavities 102 are formed in the microelectronic substrate 94, opposite the array of cavities 98. The cavities 102 hold lensed fibers 104. Each lensed fiber 100 is paired with a lensed fiber 104. The lensed fibers 100 can be selectively displaced to achieve a desired level of attenuation.

FIG. 11B shows a cross-section of the variable optical attenuator 92. As shown, the microelectronic substrate 94 is mounted on a tube 106, which has an end plate 108. A piezoelectric actuator 110 is positioned to act on the cantilever 96 as a lever. In practice, there will be a piezoelectric actuator 110 for each of the cantilevers 96 (see FIG. 11A) so that the lensed fibers 100 (see FIG. 11A) can be selectively deflected. Manufacture of piezoelectric actuators, such as piezoelectric actuator 110, is well-known to those skilled in the art.

The piezoelectric actuator 110 includes a stack of piezoelectric elements 112.

Typically, the piezoelectric material is ceramic. The piezoelectric elements 112 are separated by thin metallic electrodes 114. Bimorph piezoelectric elements can also be used in place of the piezoelectric elements 112. A bimorph piezoelectric element is made of two piezoelectric elements with different piezoelectric coefficients or a piezoelectric layer deposited on a non-piezoelectric layer.

The lower end 113 of the piezoelectric actuator 110 is secured to the end plate 108. To prevent wear between the upper end 115 of the piezoelectric actuator 110 and the cantilever 96, a ball 116 (or other suitable structure) could be mounted at the upper end 115 of the piezoelectric actuator 96. The ball 116 could be made of piezoelectric material or, more generally, a wear-resistant material. An alternative to the ball 116 is to deposit a wear-resistant film on the upper end 115 of the piezoelectric actuator 110. The wear-resistant material could be silicon nitride, diamond-like carbon, or other suitable wear-resistant material.

When a voltage is applied across the metallic electrodes 114, the piezoelectric elements 112 expand, as shown in FIG. 11C, causing the cantilever 96 to deflect. As the cantilever 96 deflects, the optical axis of the lensed fiber 100 is laterally offset from the optical axis of the lensed fiber 104, where the degree of lateral offset determines the level of attenuation achieved. Other equivalent mechanical configurations using piezoelectric or electrostrictive actuators will be apparent to those skilled in the art.

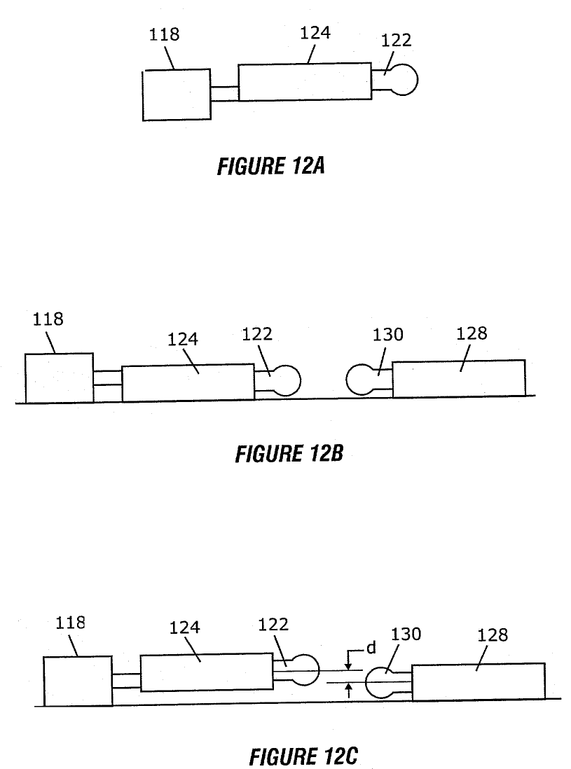

A motor can also be used to displace a lensed fiber. The motor can be arranged to act on the lensed fiber as a lever, as described for the piezoelectric actuator above, or other equivalent mechanical configurations can be used. FIG. 12A shows an alternative configuration wherein a motor 118, such as a brushless DC servo motor, is coupled to a stage 124. A lensed fiber 122 is supported on the stage 124. The lensed fiber 122 can be placed in a metal ferrule (not shown) and laser welded to the stage 124 or placed in a glass ferrule (not shown) and glued to the stage 124. Alternatively, a V-groove can be used to hold the lensed fiber 122.

FIG. 12B shows the stage 124 aligned with a structure 128, which holds a lensed fiber 130. The structure 128 could be a V-groove, metal ferrule, glass ferrule, or other suitable structure for holding the lensed fiber 130. FIG. 12C shows the motor 118 operated to laterally displace the stage 124 with respect to the structure 128.

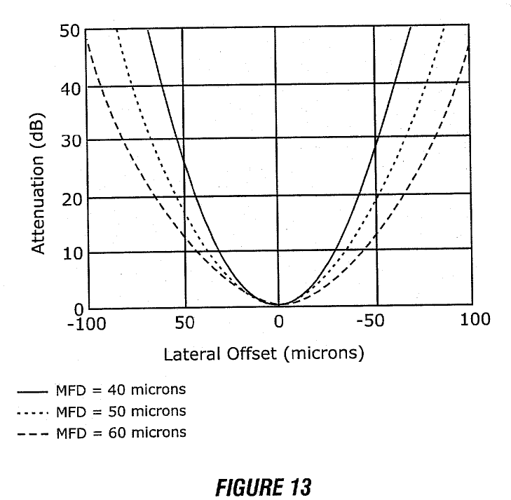

FIG. 13 shows a graph of attenuation vs. lateral displacement for three different mode field diameters. For a motor having a mechanical constant, i.e., time to reach 63% of maximum speed, under 6 ms and a maximum speed of 88,000 rpm, an attenuation speed of less than 10 ms can be achieved.

The invention provides one or more advantages. The invention provides a variable optical attenuator that is operable over a broad range of wavelengths, e.g., 1500 to 1650 nm, and does not depend on polarization. The variable optical attenuator can also be designed to work at multiple communication windows. For example, the variable optical attenuator could be designed to work at 1550 nm and at 1310 nm. The variable optical attenuator can be fabricated using low-cost techniques, such as MEMS technology. The lensed fibers facilitate miniaturization of the variable optical attenuator. Because of the use of lensed fibers, active fiber-lens alignment is not required.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A variable optical attenuator, comprising:
a pair of lensed fibers normally having their optical axes aligned; and
an actuator operable to displace at least one of the lensed fibers such that the optical axes of the lensed fibers are misaligned and an intensity of an optical signal passing between the lensed fibers is altered.

2. The variable optical attenuator of claim 1, wherein the lensed fibers have a back-reflection loss greater than −60 dB.

3. The variable optical attenuator of claim 1 having an insertion loss less than 0.2 dB.

4. The variable optical attenuator of claim 1 having a dynamic range of attenuation greater than 40 dB.

5. The variable optical attenuator of claim 1 having a capacity for operation over multiple communication windows.

6. The variable optical attenuator of claim 1, further comprising a structure for holding at least one of the lensed fibers.

7. The variable optical attenuator of claim 6, wherein the actuator is positioned to displace the structure such that the optical axes of the lensed fibers are misaligned.

8. The variable optical attenuator of claim 7, wherein the actuator is a bimetal heater.

9. The variable optical attenuator of claim 7, wherein the actuator is an electrostatic actuator.

10. The variable optical attenuator of claim 7, wherein the actuator is a magnetic actuator.

11. The variable optical attenuator of claim 7, wherein the actuator is a piezoelectric actuator.

12. The variable optical attenuator of claim 7, wherein the actuator is an electrostrictive actuator.

13. The variable optical attenuator of claim 7, wherein the actuator comprises a motor.

14. A device for attenuating an optical beam, comprising:
a microelectronic substrate having a cantilever defined therein;
a lensed fiber supported by the cantilever; and
an actuator operable to deflect the cantilever such that an optical axis of the lensed fiber is deflected from a normal position.

15. The device of claim 14, wherein the actuator comprises a bimetal strip deposited on the cantilever.

16. The device of claim 15, wherein the bimetal strip is isolated from a bulk of the microelectronics substrate by an insulating layer deposited between the bimetal strip and the cantilever.

17. The device of claim 16, further comprising means for supplying electrical current to the bimetal strip.

18. The device of claim 14, wherein the actuator comprises a first electrode deposited on the cantilever and a second electrode arranged in spaced, opposing relation to the first electrode.

19. The device of claim 18, further comprising means for applying a voltage across the electrodes.

20. The device of claim 14, wherein the actuator comprises a magnetic coil deposited on the cantilever.

21. The device of claim 20, further comprising means for generating a magnetic field proximate to the magnetic coil.

22. The device of claim 20, further comprising means for supplying current to the magnetic element.

23. The device of claim 14, wherein the actuator comprises a stack of piezoelectric elements positioned to act on the cantilever as a lever.

24. The device of claim 14, wherein the actuator comprises a stack of bimorph piezoelectric elements positioned to act on the cantilever as a lever.

25. The device of claim 14, wherein the actuator comprises a stack of electrostrictive elements positioned to act on the cantilever as a lever.

26. The device of claim 14, wherein the actuator comprises a stack of bimorph electrostrictive elements positioned to act on the cantilever as a lever.

27. The device of claim 14, wherein the actuator comprises a motor.

28. The device of claim 14, further comprising a second lensed fiber arranged in opposing relation to the lensed fiber, the second lensed fiber having an optical axis normally aligned with an optical axis of the lensed fiber.

29. A device for attenuating an optical beam, comprising:
a pair of lensed fibers normally having their optical axes aligned;
a cantilever which supports one of the lensed fibers; and
an actuator for deflecting the cantilever such that the optical axes of the lensed fibers are misaligned and an intensity of an optical signal passing between the lensed fibers is altered.

30. A device for attenuating an optical beam, comprising:
an array of cantilevers;
an array of lensed fibers supported by the array of cantilevers; and
an array of actuators operable to selectively deflect the cantilevers.

31. A device for attenuating an optical beam, comprising:
an array of cantilevers;
a first array of lensed fibers supported by the cantilevers;
a second array of lensed fibers arranged in opposing relation to the first array of lensed fibers, the second array of lensed fibers having their optical axes normally aligned with the optical axes of the first array of lensed fibers; and
an array of actuators for selectively deflecting the cantilevers such that an intensity of an optical signal passing between the first array of lensed fibers and the second array of lensed fibers is altered.

32. A method for attenuating an optical beam, comprising:
passing the optical beam between a pair of lensed fibers normally having their optical axes aligned; and
displacing at least one of the lensed fibers such that the optical axes of the lensed fibers are misaligned and an intensity of the optical beam is altered.
